(19) United States
(12) Patent Application Publication
(10) Pub. No.: US 2026/0038463 A1
(43) Pub. Date: Feb. 5, 2026

(54) Acoustic Guitar Neck Support System and Soundboard Tuning

(71) Applicant: Lloyd Baggs Innovations, LLC, Nipomo, CA (US)

(72) Inventor: Lloyd R. Baggs, Nipomo, CA (US)

(73) Assignee: Lloyd Baggs Innovations, LLC, Nipomo, CA (US)

(21) Appl. No.: 19/287,624

(22) Filed: Jul. 31, 2025

Related U.S. Application Data
(60) Provisional application No. 63/678,491, filed on Aug. 1, 2024.

(51) Int. Cl. G10D 3/02; G10D 1/08; G10D 3/06; G10D 3/22; G10H 3/18

(52) U.S. Cl. CPC G10D 3/02; G10D 1/08; G10D 3/06; G10D 3/22; G10H 3/18; G10H 2220/461

(57) ABSTRACT

Acoustic guitar neck support systems and methods for constructing are disclosed. In many embodiments of the invention, an acoustic guitar includes a body including a top, a back, and sides forming an internal cavity, a neck, an integral neck support structure configured to support the neck, the neck support structure operatively connected to the sides and not directly connected to the top or the back, the neck support structure comprising a central support region positioned within the internal cavity and at least one arm extending from the central support region to the sides, wherein the top and the back are each attached to the sides and are structurally relieved from supporting the neck in shear.

### RELATED APPLICATIONS

The present application claims priority to U.S. Patent Application No. 63/678,491 entitled Acoustic Guitar Neck Support System and Soundboard Tuning and filed Aug. 1, 2024, the disclosure of which is incorporated by reference in its entirety.

### FIELD OF THE INVENTION

The present invention relates generally to acoustic instruments and more specifically to support structures within acoustic guitars.

### SUMMARY OF THE INVENTION

In many embodiments of the invention, an acoustic guitar includes a body including a top, a back, and sides forming an internal cavity, a neck, an integral neck support structure configured to support the neck, the neck support structure operatively connected to the sides and not directly connected to the top or the back, the neck support structure comprising a central support region positioned within the internal cavity and at least one arm extending from the central support region to the sides, wherein the top and the back are each attached to the sides and are structurally relieved from supporting the neck in shear.

In further embodiments of the invention, the neck support structure and the sides are formed together as a unitary structure.

In some embodiments of the invention, the unitary structure is machined from a single blank of material selected from the group consisting of solid wood, plywood, pressed wood, and plastic.

In several embodiments of the invention, the unitary structure is molded from plastic.

In more embodiments of the invention, the neck support structure comprises a ring-shaped or cylindrical structure positioned within the internal cavity.

In still further embodiments of the invention, the sides have a thickness greater than ¼ inch.

In still more embodiments of the invention, the back includes a cutout and a removable plug or cover for mass loading to tune the resonant frequency of the back.

In further embodiments of the invention, the plug or cover has a mass selected to achieve a resonant frequency of the back that is less than or equal to one third of an octave lower than a resonant frequency of the top.

In some embodiments of the invention, a soundhole cover is mounted to or formed integrally with the neck support structure and not attached to the top or the back.

In several embodiments of the invention, the soundhole cover or plug is spaced from the top to provide a gap between the soundhole cover and the top.

In more embodiments of the invention, the gap is approximately 300/1000 inch.

In still further embodiments of the invention, the soundhole cover or plug includes an integrated or attached pickup.

In still more embodiments of the invention, the pickup is a magnetic pickup.

In further embodiments of the invention, the top and the back are each tuned by adjusting at least one of wood type, thickness, bracing, or added mass to achieve a desired resonant frequency.

In some embodiments of the invention, the resonant frequency of the back is less than or equal to one octave lower than the resonant frequency of the top.

In several embodiments of the invention, a method of manufacturing an acoustic guitar includes obtaining a blank of material for a neck support structure and sides, forming the neck support structure and sides together as a unitary structure from the blank of material, forming a top and attaching the top to the sides, forming a back and attaching the back to the sides, mounting a neck to the neck support structure, wherein the neck support structure is operatively connected to the sides and not directly connected to the top or the back, such that the top and back are structurally relieved from supporting the neck in shear.

In more embodiments of the invention, the method also includes attaching a soundhole cover to the neck support structure, the soundhole cover not attached to the top or the back.

In still further embodiments of the invention, the method also includes adding mass to the back to tune the resonant frequency of the back relative to the top.

In still more embodiments of the invention, the neck support structure and sides are machined from plywood with plies oriented perpendicular to a direction of cutting.

In further embodiments of the invention, the neck support structure and sides are molded from plastic.

In some embodiments of the invention, the method also includes testing the resonant frequencies of the top and back by inducing vibration and observing modal patterns.

### BRIEF DESCRIPTION OF THE DRAWINGS

FIG. 1 illustrates an acoustic guitar with integral neck support structure in accordance with several embodiments of the invention.

FIG. 2A illustrates a perspective view of an integral neck support structure attached to sides of the guitar in accordance with several embodiments of the invention.

FIG. 2B illustrates a cross section of a guitar with integral neck support structure in accordance with several embodiments of the invention.

FIG. 2C illustrates another cross section of a guitar with integral neck support structure in accordance with several embodiments of the invention.

FIG. 2D illustrates an integral neck support structure with a pickup mounted in accordance with several embodiments of the invention.

FIG. 2E illustrates a top view of an integral neck support structure attached to sides of the guitar in accordance with several embodiments of the invention.

FIG. 3A illustrates a perspective view of an integral neck support structure attached to sides of the guitar in accordance with several embodiments of the invention.

FIG. 3B illustrates a top view of an integral neck support structure attached to sides of the guitar in accordance with several embodiments of the invention.

FIG. 3C illustrates a perspective view of an integral neck support structure attached to sides of the guitar in accordance with several embodiments of the invention.

FIG. 3D illustrates a top view of an integral neck support structure attached to sides of the guitar in accordance with several embodiments of the invention.

FIG. 4 illustrates a process for building an acoustic guitar with integral neck support structure in accordance with several embodiments of the invention.

### DETAILED DISCLOSURE OF THE INVENTION

Turning now to the drawings, hollow body acoustic guitars with integral neck support structures are disclosed.

The top of an acoustic guitar is also often called the sound board because, due to the strings being attached to the top, a large proportion of the energy of acoustic sound waves generates from the top.

In a typical acoustic guitar, the back is mainly responsible for supporting the neck in shear with the top. The back and top typically act as tuned vibrating plates. Approximately 140 static pounds of pull from the strings is held by the back due to its connection to the neck. Accordingly, the back is often heavily braced to bear the stress that the strings impart.

Therefore, the necessary structural characteristics (e.g., thickness of the top and back, bracing of the top and back, etc.) to counteract the forces exerted on the top and back in shear act as constraints.

Many embodiments of the invention provide a novel type of support structure within the hollow body of an acoustic guitar such that the role of the top and back in supporting the neck is largely minimized or eliminated. This way, the top is no longer in shear with the back and only has to hold the string tension. When the neck is anchored to the sides, less energy is lost from string vibration into the neck structure and back, which drives more energy into the top. The neck support structure may be formed together with the sides or attached to the sides at locations below the shoulders of the guitar. With fewer constraints to the rigidity of the top and back, these pieces can be tuned for better acoustic response. For example, the top can be lighter (e.g., in thickness and/or bracing). A more flexible and responsive top bracing structure may be used, which can enhance acoustic qualities.

Moreover, the back, being relieved of holding the neck, can be tuned for better acoustic response, e.g., to resonant modes of the top and back. In this way, the back can act similarly to a passive radiator in a loudspeaker that can be tuned by mass. In some embodiments, the back can be weighted with mass such that its resonant frequency is about a major third (or other choice of tuning) below the resonant frequency of the top. The effect is to greatly enhance the lower range of the acoustic response, similar to the second skin of a kick drum. Distinct from many existing guitars, the back can be flat or close to flat (e.g., having a 10 m radius for cosmetic appearance). The back can also have very light bracing.

In several embodiments of the invention, the support structure is an integral neck support that is connected to the neck and sides and is not directly connected to the top or back. In further embodiments of the invention, the neck support is formed together with the sides unitarily. In some embodiments, the support structure and sides can be formed as a unit by machining a solid material (solid wood, plywood, pressed wood, etc.). In additional embodiments, the support structure and sides can be formed as a unit by molding plastic. In some embodiments, the support structure includes a cylindrical or ring shaped (e.g., hollow cylinder) structure within the interior of the guitar. The open face of the ring shape, or the top of the cylinder, may face the top of the guitar and may open to the soundhole opening of the top. The support structure may be approximately equal distance from the left and right sides of the guitar, and may be closer to the neck than the tail of the guitar.

### Support Structure

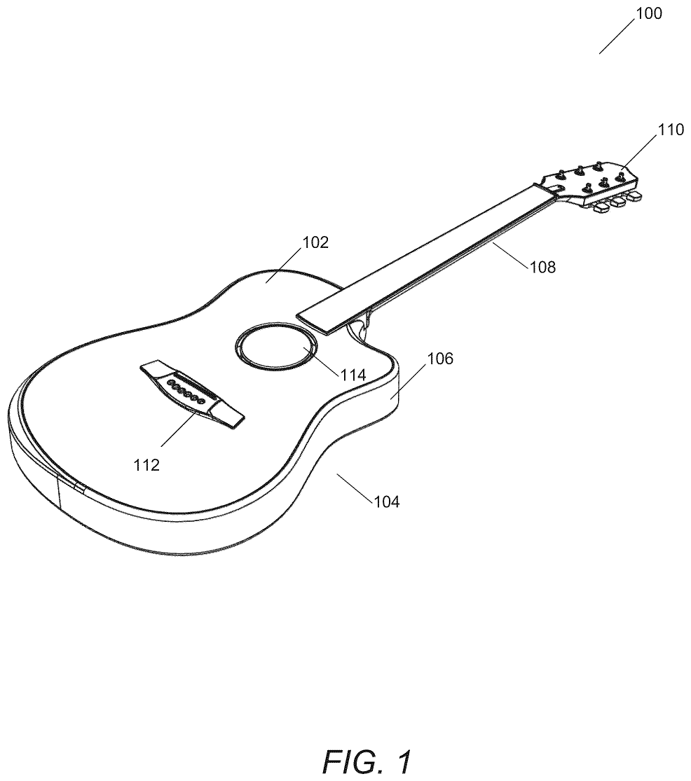

An acoustic guitar in accordance with many embodiments of the invention is illustrated in FIG. 1. The guitar includes a top 102, a back 104 (underside not shown), and sides 106 forming the body of the guitar. The guitar also includes a neck 108, and a headstock 110 and a bridge 112 for securing the strings. A soundhole cover 114 occupies some of the open space formed by the soundhole.

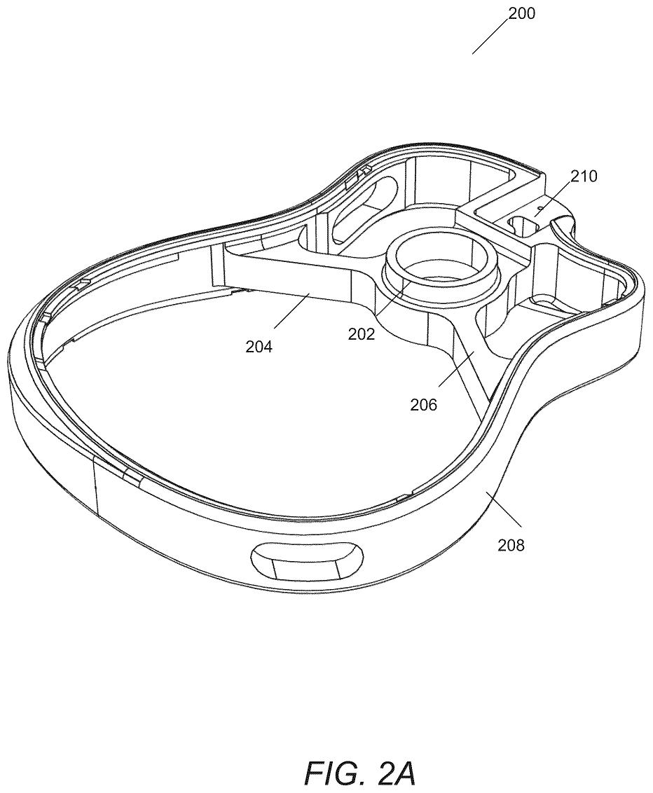

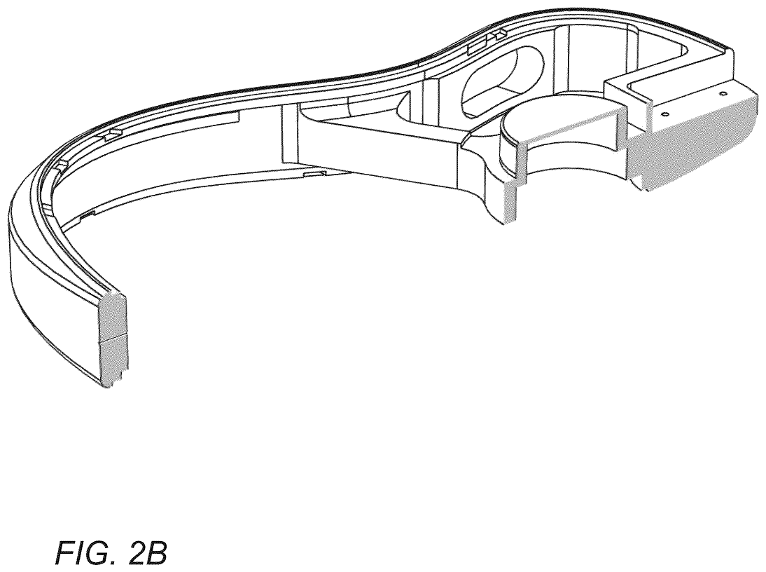

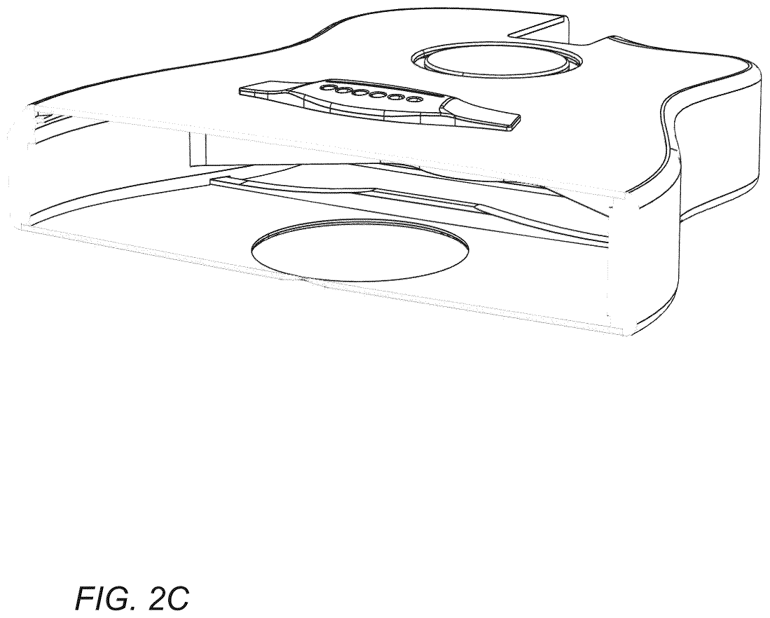

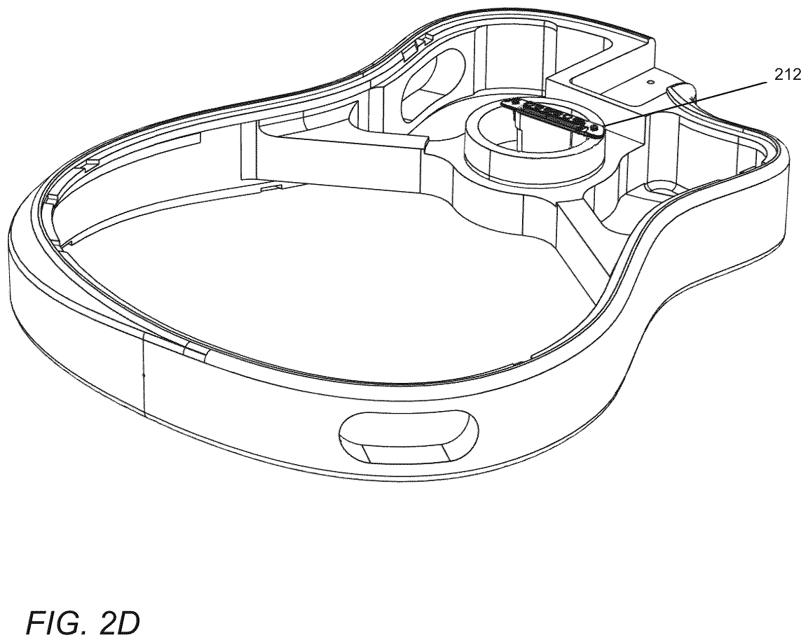

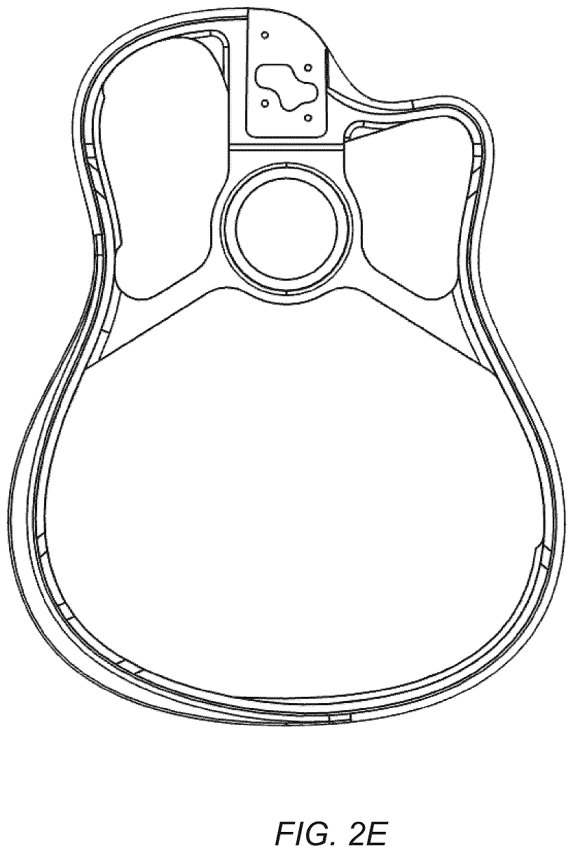

An integral neck support structure together with sides of a guitar in accordance with many embodiments of the invention are illustrated in FIG. 2. The integral neck support structure 200 includes a central ring 202, and arms 204 and 206 that join the central ring 202 to the sides 208. A neck block 210 is also integrated into the support structure for attachment of and to support the neck.

A cross-sectional view of an acoustic guitar in accordance with some embodiments of the invention is shown in FIG. 2B.

In certain embodiments of the invention, the sides of the guitar are thicker than on a typical acoustic guitar (typically around 90/1000″). A thickness of greater than ¼″ (e.g., 300/1000″) can be rigid enough for the sides as part of the support structure to allow the neck support and central ring to be robust. As well, the thickness of the sides can be lesser or greater than ¼″ for certain embodiments of the invention.

In some embodiments, the sides are cut to their final curvature such as by the process discussed further below, rather than bent and/or formed into their final shape as in typical acoustic guitars.

Another cross-sectional view of an acoustic guitar in accordance with some embodiments of the invention is shown in FIG. 2C. This cross-sectional view shows one technique for how the top and back may be fit and attached to the sides. A shoulder may be cut into the sides that forms a ledge that the top can fit to. Similarly, the bottom may be fit to the side across from the top. In other embodiments of the invention, the sides may simply have a flat surface. The top can be attached to the sides by clamping and gluing to flat surface and the back can be attached in similar fashion. It will be appreciated by someone skilled in the art that the top and back can be attached with different methods including traditional methods without the need for cutouts to inset the top and/or back to the sides.

FIG. 2D shows a view of neck support structure and sides of an acoustic guitar with a pickup 212 attached to the soundhole or to a soundhole plug mounted in the soundhole in accordance with embodiments of the invention. The pickup 212 may be a magnetic pickup or other type of pickup. In some embodiments, the soundhole plug may be formed integrally with the central ring or other part of the neck support structure.

Typically, in an acoustic guitar, adding a pickup and/or a soundhole cover would add mass to the top, which can be undesirable in changing the acoustic response. When the soundhole plug is mounted to or part of the neck support structure and is independent of the top and back in accordance with embodiments of the invention, the impact of this added mass to the acoustic response is largely minimized or eliminated.

Furthermore, all acoustic guitars typically have a Helmholtz resonance, which can occur when air is forced into and out of a cavity. The frequency of this resonance (usually around 100 Hz) is often difficult to overcome when it occurs in feedback. A soundhole plug that is part of or mounted to the neck support structure in accordance with embodiments of the invention can reduce or eliminate the feedback at this frequency while still allowing flexibility of the top. The soundhole plug may allow a 300/1000″ gap to the soundboard (top) and may be hollowed out from behind as shown in FIG. 2B.

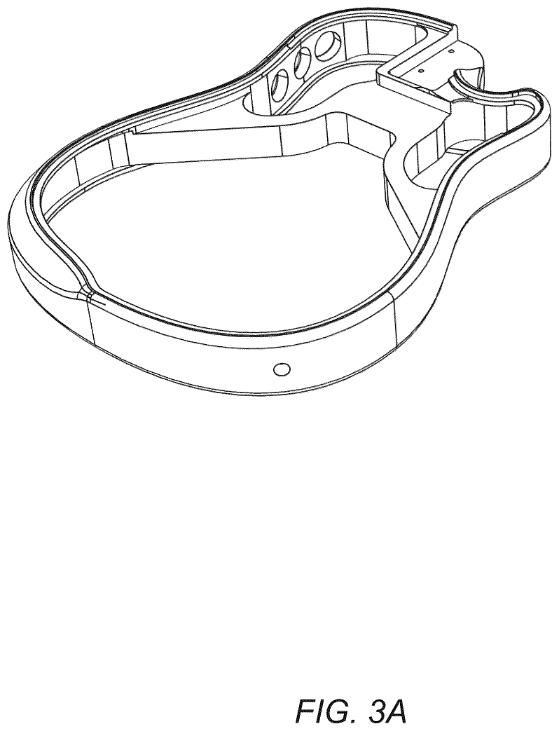

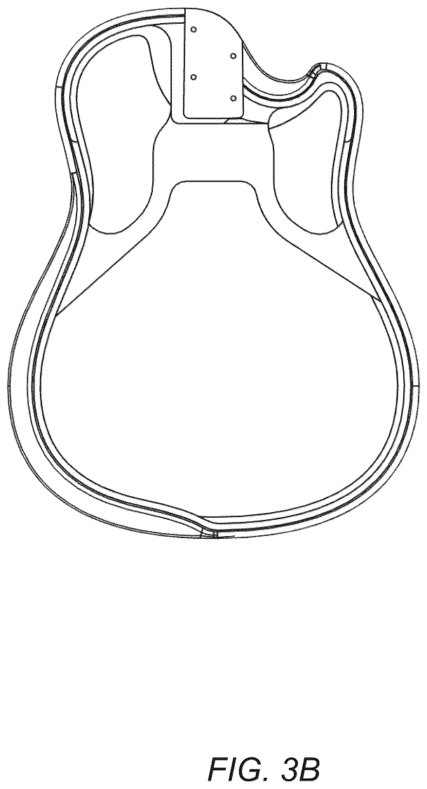

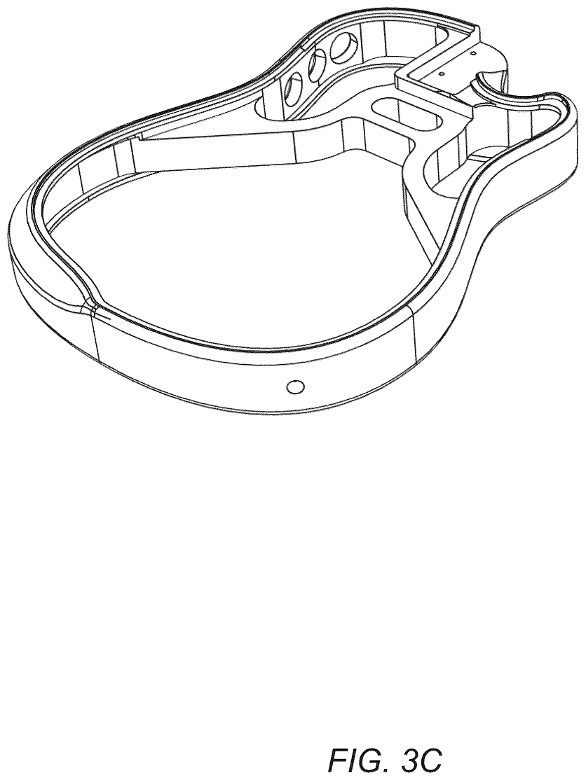

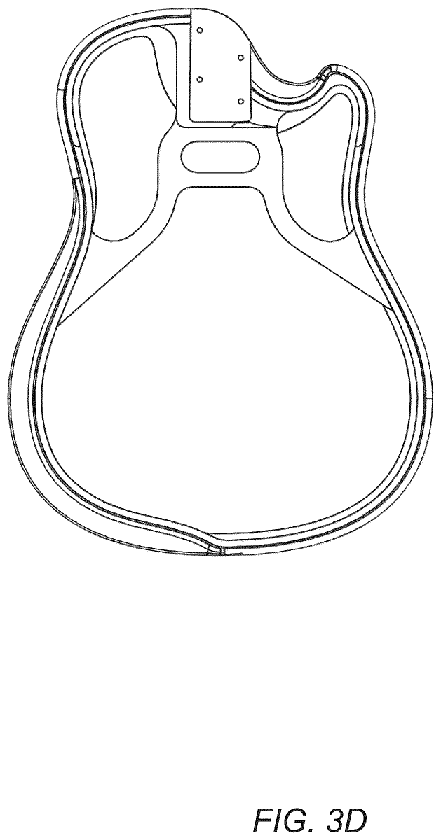

Another view of the integral neck support structure is shown in FIG. 2E. Additional embodiments of the invention are illustrated in FIGS. 3A, 3B, 3C, and 3D. Although a specific acoustic guitar and support structure are shown in FIGS. 1-3, one skilled in the art will recognize that any of a variety of guitar and support structure designs may be utilized in accordance with embodiments of the invention.

### Processes for Manufacturing

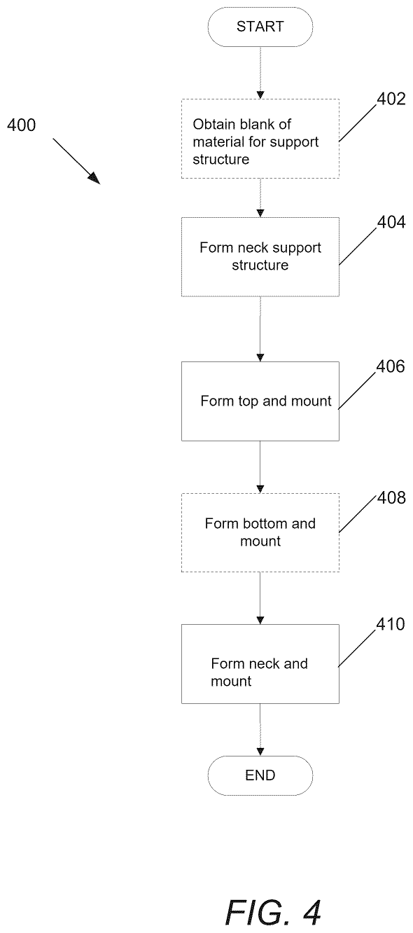

In many embodiments of the invention, a key part of the manufacturing or building of an acoustic guitar is forming the neck support structure and the sides together as a unit. Alternatively, the neck support structure and the sides may be formed separately, and then attached together. Furthermore, the neck support structure and sides may be the same material. A process for manufacturing an acoustic guitar with integral neck support structure in accordance with several embodiments of the invention is illustrated in FIG. 4.

The process 400 includes obtaining (402) a blank of material for the neck support structure. In some embodiments of the invention, the blank may be a piece of plywood where the direction of the plies is perpendicular to the direction of cutting. In other embodiments, the blank may be plastic or other structural materials, such as uniform or composite materials.

A neck support structure and sides are formed (404) together from the blank of material. For example, if plywood is used, the blank may be machined to remove material leaving the shape of the neck support structure and sides. If plastic is used, the neck support structure and sides may be molded together out of the material. In alternative embodiments of the invention, the neck support structure may be formed separately from the sides and then attached to the sides. In some embodiments of the invention, the neck support structure includes a central ring whose opening faces the top of the guitar.

A top is formed (406) from any of a variety of materials, e.g., wood, to a particular thickness. Bracing is attached to the top, if any. A soundhole may be cut into the top. The top is mounted to the sides of the guitar. In some embodiments of the invention, where the neck support structure includes a central ring, the opening of the central ring aligns with the soundhole of the top.

A bottom is formed (408) from any of a variety of materials, e.g., wood, to a particular thickness. In several embodiments, mass is attached to tune the resonant frequency of the bottom as discussed further below. The mass may be implemented as a cover or plug over a hole in the back. Bracing is attached to the bottom, if any. The bottom is mounted to the sides of the guitar.

A neck is formed (410) from any of a variety of materials, e.g., wood. The neck is mounted to the neck support structure.

Additional parts of the guitar may be formed and attached, such as, but not limited to, a headstock, a bridge, etc.

Although a specific process is described above with respect to FIG. 4, one skilled in the art will recognize that any of a variety of processes may be utilized in accordance with embodiments of the invention.

### Top and Back Tuning

As discussed further above, neck support structures in accordance with certain embodiments of the invention relieve the top and back of the guitar from supporting the neck. Removing this constraint allows more liberty for a guitar builder to “tune” the top and/or back, that is to design it to have a particular resonant frequency. An optimal relationship can be found between the resonant frequencies of the top and of the back. The primary resonant frequency can be called the ring mode.

Conventionally, guitar builders tend to build so that the resonance of the back is higher than the resonance the top. On a typical acoustic guitar, the back has a resonant frequency that is ⅓ to ½ octave higher than the top (due to any combination of mass, thickness, bracing, etc.). For example, if the top is tuned to G, the back is tuned to the B above. This characteristic is further exaggerated in many narrow body guitars such as those having a “nut bowl” type of construction, where the back and sides are cut or hollowed out of one piece of wood. Nut bowl guitars often have a back with resonant frequency at least one to two octaves higher than the top due to greater thickness.

In some embodiments of the invention, the back of the guitar is designed with a resonant frequency that is less than 1 octave above the resonant frequency of the top. In several embodiments, the resonant frequency of the back is the same or as much as 1 octave or more lower than the resonant frequency of the top of the guitar. This can help to reinforce low frequencies produced by the guitar.

Tuning the top or back of a guitar to a particular resonant frequency can be achieved by any of a variety of methods including, but not limited to, the type of wood, changing the thickness, adding mass (e.g., mounted to the underside), changing the bracing (e.g., amount or type), or other construction choices. Often the design of a guitar involves planning for a particular construction having these characteristics and projecting what the resonant frequency will be. Once constructed, it can be tested for the resonant frequency by inducing vibration in the surface (the top or the back) with a frequency sweep and observing for Chladni patterns that indicate the modes. the construction can be replicated by building another guitar having the same characteristics and the resulting guitar will usually have resonant frequencies within 5-10% of the target design tuning.

The thickness of the back can be similar to that of other acoustic guitars, e.g., around 100/1000″ or in the range of 90/1000″ to 125/1000″. It can be substantially flat, or it can be around 35 to 40 foot spherical radius to resist deformation of the shape due to humidity, whereas conventional acoustic guitars are typically 16 to 25 foot spherical radius vertical and horizontal.

In some additional embodiments of the invention, the back may have a cutout. The cutout can allow for access to the bridge and underside of the top. A plug or cover may also be placed in the cutout. It can be used for mass loading by selecting an appropriate mass of the plug or cover to determine the overall mass of the back. Some embodiments of the invention may utilize a cover of 100 grams over the cutout.

Further embodiments of the invention include a novel soundhole cover in the top of the guitar that can provide additional tuning of frequencies produced out of the guitar. Many traditional soundhole covers completely seal off air passage through the soundhole, thereby holding the air within the body captive. This restricts the top and back's free movement, and dampens the main air resonance, which is the frequency it will tend to feed back.

Soundhole covers in accordance with many embodiments of the invention provide a gap between the cover and the edge of the soundhole, which can be around 300/1000″. The presence of the gap allows some lower frequencies to escape and changes the air resonant frequency. The effect is to improve the feedback threshold of the guitar. In some embodiments of the invention, the soundhole cover is attached to the support structure and is not connected to the top or back.

While the above description contains many specific embodiments of the invention, these should not be construed as limitations on the scope of the invention, but rather as an example of one embodiment thereof. Accordingly, the scope of the invention should not be limited to the specific embodiments illustrated.

What is claimed is:

1. An acoustic guitar comprising:
a body including a top, a back, and sides forming an internal cavity;
a neck;
an integral neck support structure configured to support the neck, the neck support structure operatively connected to the sides and not directly connected to the top or the back, the neck support structure comprising a central support region positioned within the internal cavity and at least one arm extending from the central support region to the sides;
wherein the top and the back are each attached to the sides and are structurally relieved from supporting the neck in shear.

2. The acoustic guitar of claim 1, wherein the neck support structure and the sides are formed together as a unitary structure.

3. The acoustic guitar of claim 2, wherein the unitary structure is machined from a single blank of material selected from the group consisting of solid wood, plywood, pressed wood, and plastic.

4. The acoustic guitar of claim 2, wherein the unitary structure is molded from plastic.

5. The acoustic guitar of claim 1, wherein the neck support structure comprises a ring-shaped or cylindrical structure positioned within the internal cavity.

6. The acoustic guitar of claim 1, wherein the sides have a thickness greater than ¼ inch.

7. The acoustic guitar of claim 1, wherein the back includes a cutout and a removable plug or cover for mass loading to tune the resonant frequency of the back.

8. The acoustic guitar of claim 7, wherein the plug or cover has a mass selected to achieve a resonant frequency of the back that is less than or equal to one third of an octave lower than a resonant frequency of the top.

9. The acoustic guitar of claim 1, further comprising a soundhole cover mounted to or formed integrally with the neck support structure and not attached to the top or the back.

10. The acoustic guitar of claim 9, wherein the soundhole cover or plug is spaced from the top to provide a gap between the soundhole cover and the top.

11. The acoustic guitar of claim 10, wherein the gap is approximately 300/1000 inch.

12. The acoustic guitar of claim 9, wherein the soundhole cover or plug includes an integrated or attached pickup.

13. The acoustic guitar of claim 12, wherein the pickup is a magnetic pickup.

14. The acoustic guitar of claim 1, wherein the top and the back are each tuned by adjusting at least one of wood type, thickness, bracing, or added mass to achieve a desired resonant frequency.

15. The acoustic guitar of claim 14, wherein the resonant frequency of the back is less than or equal to one octave lower than the resonant frequency of the top.

16. A method of manufacturing an acoustic guitar, comprising:
obtaining a blank of material for a neck support structure and sides;
forming the neck support structure and sides together as a unitary structure from the blank of material;
forming a top and attaching the top to the sides;
forming a back and attaching the back to the sides;
mounting a neck to the neck support structure;
wherein the neck support structure is operatively connected to the sides and not directly connected to the top or the back, such that the top and back are structurally relieved from supporting the neck in shear.

17. The method of claim 16, further comprising:
attaching a soundhole cover to the neck support structure, the soundhole cover not attached to the top or the back.

18. The method of claim 16, further comprising:
adding mass to the back to tune the resonant frequency of the back relative to the top.

19. The method of claim 16, wherein the neck support structure and sides are machined from plywood with plies oriented perpendicular to a direction of cutting.

20. The method of claim 16, wherein the neck support structure and sides are molded from plastic.

21. The method of claim 16, further comprising:
testing the resonant frequencies of the top and back by inducing vibration and observing modal patterns.
